(19) United States
(12) Patent Application Publication
(10) Pub. No.: US 2024/0237695 A1
(43) Pub. Date: Jul. 18, 2024

(54) ENVIRONMENT-FRIENDLY SHELLING SYSTEM AND SHELLER WITH MULTILAYER MODULES THEREOF

(71) Applicant: Qingdao WoLong Peanut Machinery Co., Ltd, Qingdao City (Shandong Province) (CN)

(72) Inventor: Dezhang CHEN, Qingdao City (CN)

(73) Assignee: Qingdao WoLong Peanut Machinery Co., Ltd, Qingdao City (Shandong Province) (CN)

(21) Appl. No.: 18/189,893

(22) Filed: Mar. 24, 2023

(30) Foreign Application Priority Data
Jan. 13, 2023 (CN) 2023200811877

(51) Int. Cl. A23N 5/01

(52) U.S. Cl. CPC A23N 5/01

(57) ABSTRACT

An environment-friendly shelling system and a sheller with multilayer modules thereof is provided, which relates to the technical field of agricultural processing devices. The sheller including a cylinder, fixed screens and rotating screens are provided in the cylinder, for each fixed screen, the fixed screen is arranged opposite to a corresponding one of the rotating screens, a shelling cavity for shelling is provided between the fixed screen and the corresponding one of the rotating screens, a mesh size of the fixed screen is greater than a mesh size of the corresponding one of the rotating screens, and a respective one of material receiving plates is coaxially provided below and co-rotated with the corresponding one of the rotating screens; feeding ports and discharging ports are provided on a side wall of the cylinder.

### CROSS REFERENCE TO RELATED APPLICATION

This patent application claims the benefit and priority of Chinese Patent Application No. 2023200811877, entitled “ENVIRONMENT-FRIENDLY SHELLING SYSTEM AND SHELLER WITH MULTILAYER MODULES THEREOF” filed on Jan. 13, 2023, the disclosure of which is incorporated by reference herein in its entirety as part of the present application.

### TECHNICAL FIELD

The present disclosure relates to the technical field of agricultural processing equipment, and in particular, to an environment-friendly shelling system and a sheller with multilayer modules thereof.

### BACKGROUND ART

Peanut, also known as groundnut, is a kind of nut with abundant production and extensive consumption in China and has abundant nutrition and economic value. Peanut also has abundant medicinal value, such as anti-ageing, blood coagulation and hemostasis, blood nourishing and lactation, enhanced memory, cholesterol reduction, and prevention of tumors. In China, yield per unit area, total yield and export quantity of peanuts all the head of the world's major peanut production nations. During production of peanuts, industrial processes such as plough, irrigation, and planting and maintenance have basically achieved mechanisation. However, the production processes such as sowing, film-laying, harvesting, fruit picking and shelling have few mechanical equipment varieties, and the performance and the quality of the mechanical equipment cannot fully meet the requirements.

Traditional shelling method for the peanut uses a manual peel-off method, which is time-consuming and laborious. The efficiency of peel-off is greatly affected by the working attitude and the working capacity of a worker. The manual peel-off method is not conducive to facilitating production and processing in the peanut industry. It is necessary to use a mechanical automatic method to improve the processing stage, so as to improve the working efficiency.

Chinese Patent Application Publication No. CN109105912A discloses a peanut sheller with high peeling efficiency, including an outer cylinder and a roller arranged coaxially. The roller is located inside the outer cylinder, and a cavity is formed between an inner wall of the outer cylinder and an outer wall of the roller. The inner wall of the outer cylinder is axially provided with a filter screen, and the filter screen is inclined downwards in the direction of from the outer cylinder to the roller. The outer wall of the roller is provided with an extrusion plate which can cooperate with the filter screen to extrude the peanut after the roller rotates. The filter screen and the extrusion plate separate the cavity into a shell peeling cavity and a storage cavity distributed up and down. And, the filter screen and the extrusion plate are respectively located at two sides of a vertical center line of a cross section circle of the roller. A feeding port is provided on the outer cylinder, and the feeding port is in communication with the shell peeling cavity at one side of the extrusion plate. A dreg discharge port is provided on a wall of the roller. The dreg discharge port is located in the shell peeling cavity close to the filter screen, and is located in the storage cavity after the roller rotates. A partition plate is axially fixed in the roller. A horizontal plane of the partition plate is lower than a horizontal plane of the bottom end of the filter screen. In this solution, the peanut is squeezed and peeled by the filter screen and the extrusion plate, and the peanut kernels are extruded and then passed through the filter screen and entered the storage cavity. However, this document does not disclose the technical solution that a fixed screen and a rotating screen are arranged to be opposite to each other vertically in the cylinder, and the peanut is peeled via a shell peeling cavity formed between the fixed screen and the rotating screen.

Chinese Patent No. CN215836971U discloses a vertical peanut sheller. A feeding port and a discharging port are provided on a side wall of a cylinder of this vertical peanut sheller, and a shelling mechanism and a rotating shaft are mounted in an inner cavity of the cylinder. The shelling mechanism includes a screen, a lapping plate and a material sliding plate. The screen is horizontally arranged, the feeding port is located above the screen, and the edges of the screen all extend to the inner wall of the cylinder. The lapping plate is radially mounted on the rotatable rotary shaft and extends horizontally outwards. And, the bottom face of the lapping plate is obliquely arranged, and the lapping plate is located above the screen, so that there is a space between the lapping plate and the screen. The bottom face of the lapping plate faces the surface of the screen, and an included angle between the bottom face of the lapping plate and the surface of the screen is an acute angle. The material sliding plate is obliquely arranged, and an edge thereof extends to an inner wall of the cylinder. The bottom end of the material sliding plate is aligned with the discharge port. In this solution, the lapping plate and the screen are arranged up and down, and depend on the rotation of the lapping plate and the inclination angle of the bottom face thereof, thereby forming a lapping shell space for the peanut, and cooperating with the material sliding plate arranged inclined vertically to discharge material. However, this document does not disclose technical solution that a fixed screen and a rotating screen are arranged to be opposite to each other vertically in a cylinder to form a peanut shell peeling cavity, and a co-rotational material receiving plate is coaxially provided under the rotating screen to discharge the material.

### SUMMARY

An object of the present disclosure is to provide an environment-friendly shelling system and a sheller with multilayer modules thereof. In order to solve the problems existing in the described prior art, the present disclosure is provided with fixed screens and rotating screens, and each of the fixed screens is arranged opposite to a corresponding one of the rotating screens in an up-down direction. The peanuts fall from the fixed screen into a shelling cavity, and peanut shells can be shear-pressed and grated by a rotation of the rotating screen and an extrusion of surfaces of both the fixed screen and the rotating screen adjacent thereto. Peanut kernels and broken peanut shells can fall from the rotating screen onto a rotated material receiving plate. Thus, the peanut can be stripped off and conveyed efficiently, and the production efficiency is improved.

The present disclosure provides a sheller with multilayer modules, the sheller including a cylinder, fixed screens and rotating screens are provided in the cylinder, for each fixed screen, the fixed screen is arranged opposite to a corresponding one of the rotating screens, a shelling cavity for shelling is provided between the fixed screen and the corresponding one of the rotating screens, a mesh size of the fixed screen is greater than a mesh size of the corresponding one of the rotating screens, and a respective one of material receiving plates is coaxially provided below and co-rotated with the corresponding one of the rotating screens; feeding ports and discharging ports are provided on a side wall of the cylinder, one of the feeding ports is provided above the fixed screen, and one of the discharging ports is provided between the corresponding one of the rotating screens and the respective one of the material receiving plates.

In some embodiments, the cylinder may include a top-layer cylinder body, multiple middle-layer cylinder bodies, and a bottom-layer cylinder body which are arranged from top to bottom in sequence, a bottom of the top-layer cylinder body may be provided with a first fixed screen of the fixed screens, a top of each of the multiple middle-layer cylinder bodies may be provided with a first rotating screen of the rotating screens, a bottom of each of the multiple middle-layer cylinder bodies may be provided with a second fixed screen of the fixed screens, and a top of the bottom-layer cylinder body may be provided with a second rotating screen of the rotating screens; a side wall of the top-layer cylinder body may be provided with a first feeding port of the feeding ports, and the first feeding port may be provided above the first fixed screen; a side wall of each of the multiple middle-layer cylinder bodies may be provided with a first discharging port of the discharging ports and a second feeding port of the feeding ports, and the first discharging port and the second feeding port may be respectively arranged above and below a first material receiving plate of the material receiving plates; a side wall of the bottom-layer cylinder body may be provided with a second discharging port of the discharging ports, and the second discharging port may be provided between a second material receiving plate of the material receiving plates and the second rotating screen.

In some embodiments, the top of each of the multiple middle-layer cylinder bodies and the top of the bottom-layer cylinder body may be provided with respective retainer rings, for each of the retainer rings, an inner side wall of the retainer ring may be connected to an end of a corresponding one of both the first rotating screen and the second rotating screen, and an outer side wall of the retainer ring may be provided with a driven part which is matched with an output end of a driver.

In some embodiments, each of the multiple middle-layer cylinder bodies may be provided with a first central shaft and a first support plate, and the bottom-layer cylinder body may be provided with a second central shaft and a second support plate, an inner side wall of each of the multiple middle-layer cylinder bodies may be connected to an end part of the first support plate, and an inner side wall of the bottom-layer cylinder body may be connected to an end part of the second support plate, a center of the first support plate and a center of the second support plate may be rotatably connected to a bottom of the first central shaft and a bottom of the second central shaft respectively, a middle and a top of the first central shaft may be respectively connected to the first material receiving plate and the first rotating screen, and a middle and a top of the second central shaft may be respectively connected to the second material receiving plate and the second rotating screen.

In some embodiments, a first circular-truncated-cone-shape sliding plate and a second circular-truncated-cone-shape sliding plate may be sleeved on the first central shaft and the second central shaft respectively, a top of the first circular-truncated-cone-shape sliding plate and a top of the second circular-truncated-cone-shape sliding plate may be connected to a top of the first central shaft and a top of the second central shaft respectively, and a bottom of the first circular-truncated-cone-shape sliding plate and a bottom of the second circular-truncated-cone-shape sliding plate may be connected to an upper surface of the first material receiving plate and an upper surface of the second material receiving plate respectively.

In some embodiments, a first material baffle may be provided between the first material receiving plate and the first rotating screen, the first material baffle may be vertically suspended on an upper surface of the first material receiving plate, one end of the first material baffle which is adjacent to a corresponding one of the middle-layer cylinder bodies may be connected to a side edge of the first discharging port, and an other end of the first material baffle extends to a side face of the first circular-truncated-cone-shape sliding plate; a second material baffle may be provided between the second material receiving plate and the second rotating screen, the second material baffle may be vertically suspended on an upper surface of the second material receiving plate, one end of the second material baffle which is adjacent to the bottom-layer cylinder body may be connected to a side edge of the second discharging port, and an other end of the second material baffle extends to a side face of the second circular-truncated-cone-shape sliding plate.

In some embodiments, further including a support rod, the support rod may be provided, from top to bottom, with multiple cantilever connectors rotatably connected thereto, and a cantilever end of each of the cantilever connectors may be connected to a corresponding one of the side wall of the top-layer cylinder body, the side wall of each of the middle-layer cylinder bodies and the side wall of the bottom-layer cylinder body.

In some embodiments, a first lateral U-shaped positioning support may be disposed between the top-layer cylinder body and one of the middle-layer cylinder bodies which is adjacent to the top-layer cylinder body; a second lateral U-shaped positioning support may be disposed between the bottom-layer cylinder body and one of the middle-layer cylinder bodies which is adjacent to the bottom-layer cylinder body; and a third lateral U-shaped positioning support may be disposed between every adjacent two of the middle-layer cylinder bodies.

The present disclosure also provides an environment-friendly shelling system, the environment-friendly shelling system including: a nutshell and kernel separating machine used for separating a kernel and a nutshell, the nutshell and kernel separating machine is placed beside the sheller with multilayer modules, and the first discharging port of the side wall of each of the multiple middle-layer cylinder bodies and the second discharging port are connected to a top inlet pipeline of the nutshell and kernel separating machine.

In some embodiments, further including a dust remover for removing dust from the nutshell, a dust removal pipe of the dust remover may be connected to a pipeline of the first discharging port of the side wall of each of the multiple middle-layer cylinder bodies and the second discharging port.

The present disclosure achieves the following technical effects with respect to the prior art.
(1) In embodiments, fixed screens and rotating screens are provided, and each of the fixed screens is arranged opposite to a corresponding one of the rotating screens in an up-down direction. The peanuts fall from the fixed screen into a shelling cavity, the peanuts can be limited by an extrusion of the upper and lower screen surfaces adjacent to each other, in conjunction with the rotation of the rotating screen. In this way, a shear on the peanuts in the shelling cavity is formed, so that the peanut shells are grated and fallen down onto the material receiving plate through the rotating screen. Based on the rotational centrifugation of the material receiving plate, the peanut kernels and the broken peanut shells can be actively discharged out through the discharging port in time. Compared with the prior art in which a rotating twisting plate is provided above the shelling cavity to cooperate with a non-rotating screen below, the present disclosure can ensure that the peanuts enter the shelling cavity more smoothly. Compared with the prior art in which a vertical inclined slide material plate receives the broken peanut shells and the peanut kernels, the present disclosure provides a horizontal material receiving plate rotating together with a rotating screen, and a material baffle fixed and inclined at a certain angle relative to a axial direction of the rotating screen, the material can be quickly conveyed to the discharging port by means of the rotation of the horizontal material receiving plate cooperating with the inclined blocking of the material baffle. And, the vertical space can be relatively saved, so that the height setting requirements for the cylinder can be reduced. And, the present disclosure can realize the efficient shell peeling and the efficient conveying for the peanuts, thereby improving the production efficiency.
(2) In embodiments, several cylinder bodies are provided in sequence from top to bottom, multiple layers of shelling cavities are formed between every two adjacent cylinder bodies. Several feeding ports and several feeding ports are provided on the side walls of the cylinder bodies in cooperation with the shelling cavities, the simultaneous operation of multiple shelling unit groups can be achieved, and the operation efficiency of the whole sheller is improved. And, the various shelling unit groups do not affect each other due to separately feeding, shelling and discharging, thereby improving the emergency applicability of the whole sheller.
(3) In embodiments, the stability between adjacent cylinder bodies can be maintained based on the effective support of the support rods and the positioning supports. When the sheller is idle, the connection between each positioning support and a corresponding one of the cylinder bodies can be opened, and the cylinder bodies are respectively rotated around the respective support rods. The cylinder bodies can be distributed on different vertical planes, and thus different working planes are provided, which facilitates the inspection and the maintenance of the cylinder bodies.

### BRIEF DESCRIPTION OF THE DRAWINGS

To describe the technical solutions in the present disclosure or in the prior art more clearly, the following briefly introduces the accompanying drawings required for describing the embodiments. Apparently, the accompanying drawings in the following description show merely some embodiments of the present disclosure, and a person of ordinary skill in the art may still derive other drawings from these accompanying drawings without creative efforts.

FIG. 1 is an overall structural diagram of an environment-friendly shelling system and a sheller with multilayer modules thereof according to embodiments of the present disclosure;

FIG. 2 is a sectional structural diagram of the sheller with multilayer modules in FIG. 1;

FIG. 3 is an exploded structural diagram of layers of cylinder bodies of the sheller with multilayer modules in FIG. 1;

FIG. 4 is a structural diagram of a middle-layer cylinder body in FIG. 3;

FIG. 5 is a top view of the middle-layer cylinder body in FIG. 4

FIG. 6 is a side view of the middle-layer cylinder body in FIG. 4; and

FIG. 7 is a sectional view taken along line A-A in FIG. 6.

Reference signs: 1 fixed screen; 2 rotating screen; 3 material receiving plate; 301 rotation direction of material receiving plate; 4 feeding port; 5 discharging port; 6 top-layer cylinder body; 7 middle-layer cylinder body; 8 bottom-layer cylinder body; 9 retainer ring; 10 chain; 11 driver; 12 central shaft; 13 support plate; 14 circular-truncated-cone-shape sliding plate; 15 material baffle; 16 support rod; 17 cantilever connector; 18 positioning support; 19 nutshell and kernel separating machine; 20 top inlet; 21 dust remover; 22 sheller.

### DETAILED DESCRIPTION OF THE EMBODIMENTS

The following clearly and completely describes the technical solutions in the embodiments of the present disclosure with reference to the accompanying drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall belong to the scope of protection of the present disclosure.

An object of the present disclosure is to provide an environment-friendly shelling system and a sheller with multilayer modules 22 thereof. In order to solve the problems existing in the described prior art, the present disclosure is provided with fixed screens 1 and rotating screens 2, each fixed screen and a corresponding one of the rotating screens are opposite to each other in an up-down direction. The peanuts fall from the fixed screen 1 into a shelling cavity, and peanut shells can be shear-pressed and grated by a rotation of the rotating screen 2 and an extrusion of surfaces of the two screens. Peanut kernels and broken peanut shells can fall from the rotating screen 2 to a rotated material receiving plate 3. Thus, the peanut can be stripped off and conveyed efficiently, and the production efficiency is improved.

To make the foregoing objectives, features, and advantages of the present disclosure clearer and more comprehensible, the following further describes the present disclosure in detail with reference to the accompanying drawings and specific embodiments.

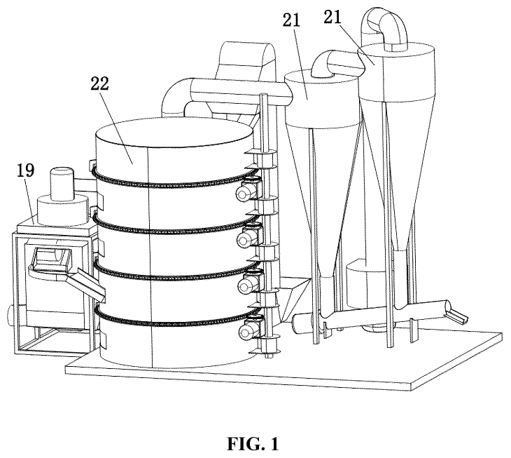

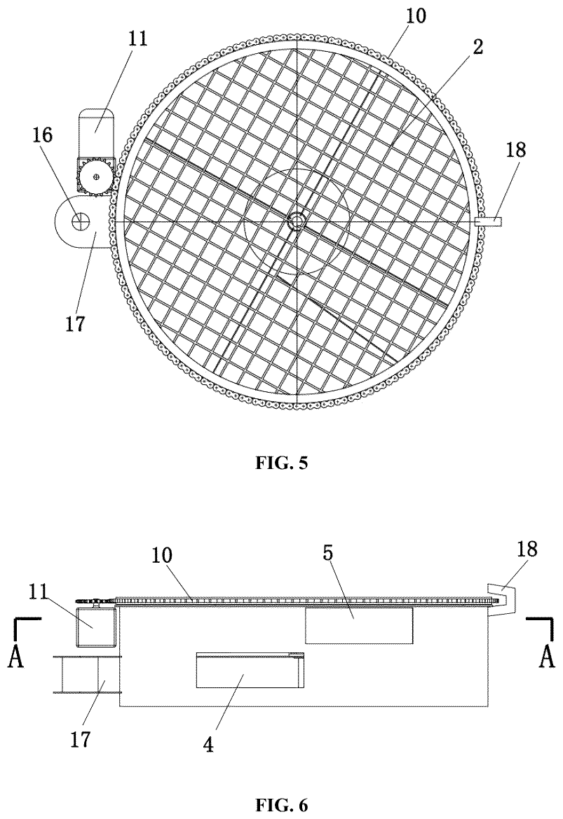

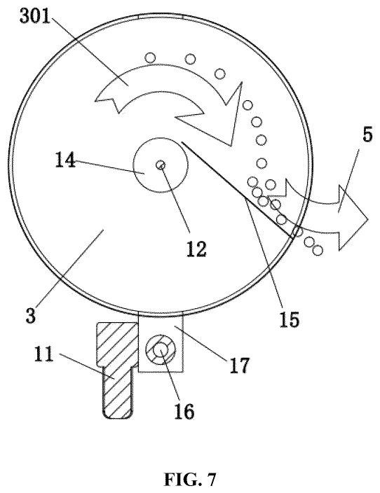

As shown in FIGS. 1-6, the sheller with multilayer modules 22 in the present disclosure includes a cylinder. Each fixed screen 1 and a corresponding one of the rotating screen 2 arranged opposite to each other are provided in the cylinder. A shelling cavity used for shelling is provided between the fixed screen 1 and the rotating screen 2. A mesh size of the fixed screen 1 is greater than a mesh size of the rotating screen 2, and a material receiving plate 3 which is co-rotating with the rotating screen 2 is coaxially provided below the rotating screen 2. A feeding port 4 and a discharging port 5 are provided on a side wall of the cylinder, the feeding port 4 is provided above the fixed screen 1, and the discharging port 5 is provided between the rotating screen 2 and the material receiving plate 3. When the peanuts enter the cylinder from the feeding port 4 and fall on the fixed screen 1, the mesh size of the fixed screen 1 is greater than that of the peanut, which can ensure that the peanuts fall from the fixed screen 1 into the shelling cavity. The shelling cavity herein may be enclosed by a lower surface of the fixed screen 1, an upper surface of the rotating screen 2, and a side wall of the cylinder. A height of the shelling cavity can be determined according to the size of the peanut. Preferably, the height of the shelling cavity is 3 cm. The mesh size of the rotating screen 2 is smaller than the size of the peanut and larger than the size of the peanut kernel, which can ensure that the broken peanut shells and peanut kernels fall onto the material receiving plate 3, and prevent the unpeeled peanuts from falling onto the material receiving plate 3. By providing the fixed screen 1 which does not rotate on the shelling cavity, since the position of the mesh is not changed, the peanuts falling on the surface of the fixed screen 1 can quickly enter the shelling cavity through the mesh of the fixed screen 1. By arranging the rotating screen 2 rotating around a shaft under the shelling cavity, the peanuts can be limited by the upper and lower screen surfaces, in conjunction with the rotation of the rotating screen 2, a shear on the peanuts in the shelling cavity is formed, so that the peanut shells are grated and fall down onto the material receiving plate 3 through the rotating screen 2. Preferably, a material baffle 15 is provided between the material receiving plate 3 and the rotating screen 2. The material baffle 15 is vertically suspended on an upper surface of the material receiving plate 3. One end of the material baffle 15 which is close to the cylinder is connected to a side edge of the discharging port 5. The material baffle 15 is connected to an inner side wall of the cylinder, and does not rotate along with the rotation of the material receiving plate 3. The lower end of the material baffle 15 can be just attached to the upper surface of the material receiving plate 3, or there is a gap smaller than the broken peanut shell and the peanut kernel. An other end of the material baffle 15 which is away from the inner side wall of the cylinder extends to the side face of the circular-truncated-cone-shape sliding plate 14. The bottom of the material baffle 15 may be just attached to the bottom of the side face of the circular-truncated-cone-shape sliding plate 14, or there is a gap smaller than the broken peanut shell and the peanut kernel, so as to ensure that the material baffle 15 can block the materials transferred on the material receiving plate 3 in time and discharge the same to the discharging port 5. Thus, the influence of the rotation of the material receiving plate 3 is reduced to a maximum extent. Based on the rotational centrifugation of the material receiving plate 3, the peanut kernels and the broken peanut shells can be actively discharged out through the discharging port 5 in time. Compared with the prior art in which a rotating twisting plate is provided above the shelling cavity to cooperate with a non-rotating screen below, the present disclosure can ensure that the peanuts enter the shelling cavity more smoothly. Also, compared with the prior art in which a vertical inclined slide material plate receives the broken peanut shells and the peanut kernels, the present disclosure provides a horizontal material receiving plate 3 rotating together with a rotating screen 2, and a material baffle 15 fixed and inclined at a certain angle relative to the axial direction of the rotating screen 2, thus the material can be quickly conveyed to the discharging port 5 by means of the rotation of the horizontal material receiving plate 3 cooperating with the inclined blocking of the material baffle 15. And, the vertical space can be relatively saved, so that the height setting requirements for the cylinder can be reduced. And, the present disclosure can realize the efficient shell peeling and the efficient conveying of the peanuts, thereby improving the production efficiency.

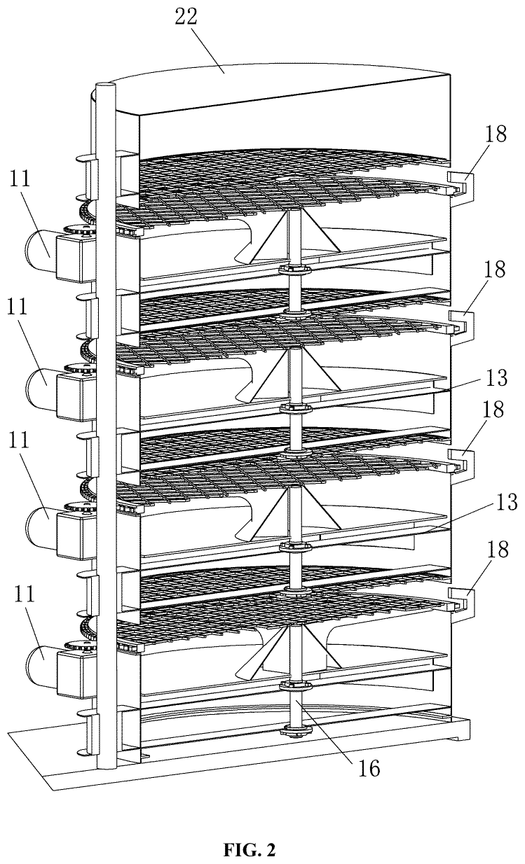

As shown in FIGS. 2-6, further, the cylinder includes a top-layer cylinder body 6, a plurality of middle-layer cylinder bodies 7, and a bottom-layer cylinder body 8 which are arranged from top to bottom in sequence. A bottom of the top-layer cylinder body 6 is provided with the fixed screen 1, a top of each of the middle-layer cylinder bodies 7 is provided with the rotating screen 2, a bottom of each of the middle-layer cylinder bodies 7 is provided with the fixed screen 1, and a top of the bottom-layer cylinder body 8 is provided with the rotating screen 2. Preferably, the distance from the bottom surface of the fixed screen 1 to the bottom of the top-layer cylinder body 6 is 3 cm; or the height can be adjusted correspondingly according to the size of the peanut varieties. The fixed screen 1 at the bottom of the top-layer cylinder body 6 and the rotating screen 2 at the top of a corresponding one of the middle-layer cylinder bodies 7 together form the shelling cavity. The shelling cavity is formed between every adjacent two of several middle-layer cylinder bodies 7 by the fixed screen 1 at the bottom of the upper cylinder body and the rotating screen 2 at the top of the adjacent lower cylinder body. The fixed screen 1 at the bottom of a corresponding one of the middle-layer cylinder bodies 7 and the rotating screen 2 at the top of the bottom-layer cylinder body 8 together form the shelling cavity. A side wall of the top-layer cylinder body 6 is provided with the feeding port 4, and the feeding port 4 is provided above the fixed screen 1. A side wall of each of the middle-layer cylinder bodies 7 is provided with the feeding port 4 and the discharging port 5, and the feeding port 4 is provided between the fixed screen 1 and the material receiving plate 3 in each of the middle-layer cylinder bodies 7. The discharging port 5 is provided between the fixed screen 1 and the rotating screen 2 in each of the middle-layer cylinder bodies 7. A side wall of the bottom-layer cylinder body 8 is provided with the discharging port 5, and the discharging port 5 is provided between the material receiving plate 3 and the rotating screen 2. In embodiments, several cylinder bodies are provided in sequence from top to bottom, multiple layers of shelling cavities are formed between every two adjacent cylinder bodies. Several feeding ports 4 and discharging ports 5 are provided on the side walls of the respective cylinder bodies in cooperation with the shelling cavities. Thus, the simultaneous operation of multiple shelling unit groups can be achieved, and the operation efficiency of the whole sheller 22 is improved. And the various shelling unit groups do not affect each other due to separately feeding, twisting shell and discharging, thereby improving the emergency applicability of the whole sheller 22.

As shown in FIGS. 4-6, further, the top of each of the middle-layer cylinder bodies 7 and the top of the bottom-layer cylinder body 8 is provided with a retainer ring 9. An inner side wall of the retainer ring 9 is connected to an end of the rotating screen 2, and an outer side wall of the retainer ring 9 is provided with a driven part which is matched with an output end of a driver 11. Preferably, the outer side wall of the retainer ring 9 is provided with a large gear ring, and an output end of the driver 11 may be a gear provided on an output shaft of an electric motor. The large gear ring is driven to rotate by the meshing between the gear and the large gear ring. Or, the outer side wall of the retainer ring 9 is wound with a chain 10, and the output end of the driver 11 may be a chain wheel provided on the output shaft of the electric motor. The chain 10 is driven to rotate by the meshing between the chain 10 and the chain wheel. Preferably, the retainer ring 9 can be rotatably lapped on the top of the cylinder body. During operation, the retainer ring 9 rotates on the top of the cylinder body and further drives the rotating screen 2 to rotate. After work, the retainer ring 9 can be removed from the top of the cylinder body to facilitate repair and maintenance, thereby improving the service life thereof. Preferably, the driver 11 may be a drive group such as an electric motor. The rotating screens 2 provided on different cylinder bodies are driven by several drivers 11 respectively. Thus, the shelling rates of multilayer shelling unit groups can be respectively controlled. And, combined with the mesh sizes of the fixed screen 1 and the rotating screen 2 in each shelling unit group, the sheller 22 can perform classification processing on different peanut sizes, thereby effectively reducing the breakage rate of peanut kernels and the residual rate of unpeeled peanuts.

Further, the middle-layer cylinder bodies 7 and the bottom-layer cylinder body 8 are each provided with a central shaft 12 and a support plate 13. An inner side wall of each of the middle-layer cylinder bodies 7 and an inner side wall of the bottom-layer cylinder body 8 are connected to an end part of the support plate 13. A center of the support plate 13 is rotatably connected to a bottom of the central shaft 12. And, a middle and a top of the central shaft 12 are respectively connected to the material receiving plate 3 and the rotating screen 2. Preferably, the center of the supporting plate 13 is provided with an aperture, and a bearing connected to the bottom of the central shaft 12 is provided in the aperture. The rotating screen 2 passes through the central shaft 12 and is connected to the top of the central shaft 12. The material receiving plate 3 passes through the central shaft 12 and is connected thereto. The driver 11 can drive the rotating screen 2 to rotate by means of the meshing of the chain 10 and the chain wheel. The rotating screen 2 drives the central shaft 12 to rotate, and the bottom of the central shaft 12 drives the material receiving plate 3 to rotate while rotating in the bearing. The stability of the rotating screen 2 and the material receiving plate 3 in the cylinder body can be ensured by providing the support plate 13 connected to the inner side wall of the cylinder body and the central shaft 12 connected with the rotating screen 2 and the material receiving plate 3.

As shown in FIG. 4, further, a circular-truncated-cone-shape sliding plate 14 is sleeved on the central shaft 12. A top of the circular-truncated-cone-shape sliding plate 14 is connected to a top of the central shaft 12, and a bottom of the circular-truncated-cone-shape sliding plate 14 is connected to an upper surface of the material receiving plate 3. When the peanuts near the central area of the rotating screen 2 is grated, the peanuts drop onto the material receiving plate 3 from the rotating screen 2. Based on the inclined surface from top to bottom of the circular-truncated-cone-shape sliding plate 14, the broken peanut shells and peanut kernels can smoothly slide to the side of the material receiving plate 3. Further, by cooperating with a horizontal material receiving plate 3 rotating together with the rotating screen 2, and a material baffle 15 fixed and inclined at a certain angle, and by means of the rotation of the horizontal material receiving plate 3 cooperating with the inclined blocking of the material baffle 15, the material can be quickly conveyed to the discharging port 5.

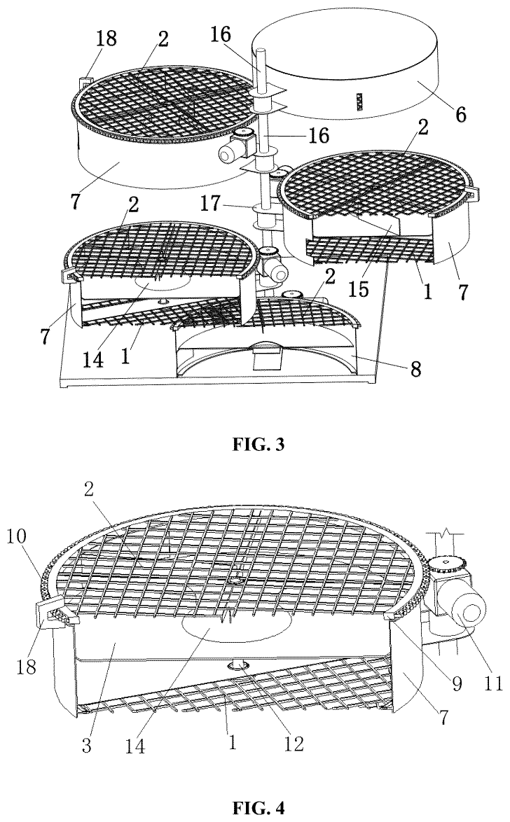

As shown in FIG. 3, the present disclosure further includes a support rod 16. The support rod 16 is provided, from top to bottom, with several cantilever connectors 17 rotatably connected thereto. And, a cantilever end of each of the cantilever connectors 17 is connected to a corresponding one of the side wall of the top-layer cylinder body 6, the side wall of each of the middle-layer cylinder bodies 7 and the side wall of the bottom-layer cylinder body 8. Lateral U-shaped positioning support 18 is respectively disposed between the top-layer cylinder body 6 and one of the middle-layer cylinder bodies 7 which is adjacent to the top-layer cylinder body; another lateral U-shaped positioning support 18 is disposed between the bottom-layer cylinder body 8 and one of the middle-layer cylinder bodies 7 which is adjacent to the bottom-layer cylinder body; and yet another lateral U-shaped positioning support 18 is disposed between every adjacent two of the middle-layer cylinder bodies 7. The positioning supports 18 are provided at one side of the cylinder body that is opposite to a side, which is connected with the cantilever connectors 17, of the cylinder body. A top side of the positioning support 18 is connected to a side wall of an adjacent upper cylinder body, a bottom side of the positioning support 18 is connected to a side wall of an adjacent lower cylinder body. Stability between adjacent cylinder bodies can be maintained and the distance between adjacent upper and lower cylinder bodies can be controlled preferably by means of the positioning supports 18. Preferably, the positioning support 18 is detachably connected to the side wall of the cylinder body. Preferably, the positioning support 18 can extend and retract to adjust the relative length between the top and the bottom thereof. Every two adjacent cylinder bodies are effectively supported by the support rod 16 and the positioning support 18, so that the relative stability of every adjacent cylinder bodies can be maintained. When the sheller 22 is idle, the connection between each positioning support 18 and the corresponding cylinder body can be opened, and the cylinder bodies are respectively rotated around the support rod 16. The cylinder bodies can be distributed on different vertical planes, and thus different working planes are provided, which facilitates the inspection and the maintenance of the cylinder bodies respectively.

As shown in FIG. 1, further, the present disclosure also discloses an environment-friendly shelling system. The environment-friendly shelling system includes a nutshell and kernel separating machine 19 used for separating a kernel and a nutshell, the nutshell and kernel separating machine 19 is placed beside the sheller with multilayer modules 22. Compared with the prior art, in which the bottom of the cylinder body is provided with a hollow area where the nutshell and kernel separating machine 19 is arranged, the environment-friendly shelling system of the present disclosure can effectively reduce the height of the sheller 22. Thus, the requirement for the height space for placing the sheller 22 can be reduced. The discharging port 5 of each of the cylinder bodies is connected to a top inlet pipeline of the nutshell and kernel separating machine 19. Preferably, the outside of the discharging port 5 is connected to a centralized channel, the centralized channel is vertically arranged, the bottom of the centralized channel is connected to a discharge elevator, and the discharge elevator is connected to the top inlet of the nutshell and kernel separating machine 19 via a pipeline.

Further, the environment-friendly shelling system further includes a dust remover 21 for removing dust from the broken peanut shells. The dust removal pipe of the dust remover 21 is connected to the top of the centralized channel. The peanut kernels and the broken peanut shells from the discharging port 5 are separated in the centralized channel. The broken peanut shells enter into a dust removal pipe, the peanut kernels fall into the bottom of the centralized channel, and the material is lifted by the discharging elevator and then is conveyed into the nutshell and kernel separating machine 19, so as to proceed to the next process.

Adaptive changes made according to practical requirements all belong to the protection scope of the present disclosure.

It should be noted that, for a person skilled in the art, the present disclosure is obviously not limited to the details of the foregoing exemplary embodiments, and the present disclosure may be implemented in other specific forms without departing from the spirit or essential features of the present disclosure. It is therefore intended that the embodiments be considered as exemplary and not restrictive. The scope of the present disclosure is limited by the appended claims rather than by the foregoing description, and all changes that come within the meaning and range of equivalency of the claims are therefore intended to be embraced therein. Any reference signs in the claims shall not be construed as limiting the claims referred to.

What is claimed is:

1. A sheller with multilayer modules, the sheller comprising a cylinder, wherein fixed screens and rotating screens are provided in the cylinder, for each fixed screen,
the fixed screen is arranged opposite to a corresponding one of the rotating screens, a shelling cavity for shelling is provided between the fixed screen and the corresponding one of the rotating screens, a mesh size of the fixed screen is greater than a mesh size of the corresponding one of the rotating screens, and a respective one of material receiving plates is coaxially provided below and co-rotated with the corresponding one of the rotating screens; feeding ports and discharging ports are provided on a side wall of the cylinder, one of the feeding ports is provided above the fixed screen, and one of the discharging ports is provided between the corresponding one of the rotating screens and the respective one of the material receiving plates.

2. The sheller with multilayer modules according to claim 1, wherein the cylinder comprises a top-layer cylinder body, a plurality of middle-layer cylinder bodies, and a bottom-layer cylinder body which are arranged from top to bottom in sequence, a bottom of the top-layer cylinder body is provided with a first fixed screen of the fixed screens, a top of each of the plurality of the middle-layer cylinder bodies is provided with a first rotating screen of the rotating screens, a bottom of each of the plurality of the middle-layer cylinder bodies is provided with a second fixed screen of the fixed screens, and a top of the bottom-layer cylinder body is provided with a second rotating screen of the rotating screens;
a side wall of the top-layer cylinder body is provided with a first feeding port of the feeding ports, and the first feeding port is provided above the first fixed screen; a side wall of each of the plurality of the middle-layer cylinder bodies is provided with a first discharging port of the discharging ports and a second feeding port of the feeding ports, and the first discharging port and the second feeding port are respectively arranged above and below a first material receiving plate of the material receiving plates; a side wall of the bottom-layer cylinder body is provided with a second discharging port of the discharging ports, and the second discharging port is provided between a second material receiving plate of the material receiving plates and the second rotating screen.

3. The sheller with multilayer modules according to claim 2, wherein the top of each of the plurality of the middle-layer cylinder bodies and the top of the bottom-layer cylinder body are provided with respective retainer rings, for each of the retainer rings,
an inner side wall of the retainer ring is connected to an end of a corresponding one of both the first rotating screen and the second rotating screen, and an outer side wall of the retainer ring is provided with a driven part which is matched with an output end of a driver.

4. The sheller with multilayer modules according to claim 2, wherein each of the plurality of the middle-layer cylinder bodies is provided with a first central shaft and a first support plate, and the bottom-layer cylinder body is provided with a second central shaft and a second support plate, an inner side wall of each of the plurality of the middle-layer cylinder bodies is connected to an end part of the first support plate, and an inner side wall of the bottom-layer cylinder body is connected to an end part of the second support plate, a center of the first support plate and a center of the second support plate are rotatably connected to a bottom of the first central shaft and a bottom of the second central shaft respectively, a middle and a top of the first central shaft are respectively connected to the first material receiving plate and the first rotating screen, and a middle and a top of the second central shaft are respectively connected to the second material receiving plate and the second rotating screen.

5. The sheller with multilayer modules according to claim 4, wherein a first circular-truncated-cone-shape sliding plate and a second circular-truncated-cone-shape sliding plate are sleeved on the first central shaft and the second central shaft respectively, a top of the first circular-truncated-cone-shape sliding plate and a top of the second circular-truncated-cone-shape sliding plate are connected to a top of the first central shaft and a top of the second central shaft respectively, and a bottom of the first circular-truncated-cone-shape sliding plate and a bottom of the second circular-truncated-cone-shape sliding plate are connected to an upper surface of the first material receiving plate and an upper surface of the second material receiving plate respectively.

6. The sheller with multilayer modules according to claim 5, wherein a first material baffle is provided between the first material receiving plate and the first rotating screen, the first material baffle is vertically suspended on an upper surface of the first material receiving plate, one end of the first material baffle which is adjacent to a corresponding one of the middle-layer cylinder bodies is connected to a side edge of the first discharging port, and an other end of the first material baffle extends to a side face of the first circular-truncated-cone-shape sliding plate; a second material baffle is provided between the second material receiving plate and the second rotating screen, the second material baffle is vertically suspended on an upper surface of the second material receiving plate, one end of the second material baffle which is adjacent to the bottom-layer cylinder body is connected to a side edge of the second discharging port, and an other end of the second material baffle extends to a side face of the second circular-truncated-cone-shape sliding plate.

7. The sheller with multilayer modules according to claim 2, further comprising a support rod, wherein the support rod is provided, from top to bottom, with a plurality of cantilever connectors rotatably connected thereto, and a cantilever end of each of the cantilever connectors is connected to a corresponding one of the side wall of the top-layer cylinder body, the side wall of each of the middle-layer cylinder bodies and the side wall of the bottom-layer cylinder body.

8. The sheller with multilayer modules according to claim 3, further comprising a support rod, wherein the support rod is provided, from top to bottom, with a plurality of cantilever connectors rotatably connected thereto, and a cantilever end of each of the cantilever connectors is connected to a corresponding one of the side wall of the top-layer cylinder body, the side wall of each of the middle-layer cylinder bodies and the side wall of the bottom-layer cylinder body.

9. The sheller with multilayer modules according to claim 4, further comprising a support rod, wherein the support rod is provided, from top to bottom, with a plurality of cantilever connectors rotatably connected thereto, and a cantilever end of each of the cantilever connectors is connected to a corresponding one of the side wall of the top-layer cylinder body, the side wall of each of the middle-layer cylinder bodies and the side wall of the bottom-layer cylinder body.

10. The sheller with multilayer modules according to claim 5, further comprising a support rod, wherein the support rod is provided, from top to bottom, with a plurality of cantilever connectors rotatably connected thereto, and a cantilever end of each of the cantilever connectors is connected to a corresponding one of the side wall of the top-layer cylinder body, the side wall of each of the middle-layer cylinder bodies and the side wall of the bottom-layer cylinder body.

11. The sheller with multilayer modules according to claim 6, further comprising a support rod, wherein the support rod is provided, from top to bottom, with a plurality of cantilever connectors rotatably connected thereto, and a cantilever end of each of the cantilever connectors is connected to a corresponding one of the side wall of the top-layer cylinder body, the side wall of each of the middle-layer cylinder bodies and the side wall of the bottom-layer cylinder body.

12. The sheller with multilayer modules according to claim 7, wherein a first lateral U-shaped positioning support is disposed between the top-layer cylinder body and one of the middle-layer cylinder bodies which is adjacent to the top-layer cylinder body; a second lateral U-shaped positioning support is disposed between the bottom-layer cylinder body and one of the middle-layer cylinder bodies which is adjacent to the bottom-layer cylinder body; and a third lateral U-shaped positioning support is disposed between every adjacent two of the middle-layer cylinder bodies.

13. An environment-friendly shelling system comprising the sheller with multilayer modules, the sheller comprising a cylinder, wherein fixed screens and rotating screens are provided in the cylinder, for each fixed screen,
the fixed screen is arranged opposite to a corresponding one of the rotating screens, a shelling cavity for shelling is provided between the fixed screen and the corresponding one of the rotating screens, a mesh size of the fixed screen is greater than a mesh size of the corresponding one of the rotating screens, and a respective one of material receiving plates is coaxially provided below and co-rotated with the corresponding one of the rotating screens; feeding ports and discharging ports are provided on a side wall of the cylinder, one of the feeding ports is provided above the fixed screen, and one of the discharging ports is provided between the corresponding one of the rotating screens and the respective one of the material receiving plates;
the cylinder comprises a top-layer cylinder body, a plurality of middle-layer cylinder bodies, and a bottom-layer cylinder body which are arranged from top to bottom in sequence, a bottom of the top-layer cylinder body is provided with a first fixed screen of the fixed screens, a top of each of the plurality of the middle-layer cylinder bodies is provided with a first rotating screen of the rotating screens, a bottom of each of the plurality of the middle-layer cylinder bodies is provided with a second fixed screen of the fixed screens, and a top of the bottom-layer cylinder body is provided with a second rotating screen of the rotating screens;
a side wall of the top-layer cylinder body is provided with a first feeding port of the feeding ports, and the first feeding port is provided above the first fixed screen; a side wall of each of the plurality of the middle-layer cylinder bodies is provided with a first discharging port of the discharging ports and a second feeding port of the feeding ports, and the first discharging port and the second feeding port are respectively arranged above and below a first material receiving plate of the material receiving plates; a side wall of the bottom-layer cylinder body is provided with a second discharging port of the discharging ports, and the second discharging port is provided between a second material receiving plate of the material receiving plates and the second rotating screen;
each of the plurality of the middle-layer cylinder bodies is provided with a first central shaft and a first support plate, and the bottom-layer cylinder body is provided with a second central shaft and a second support plate, an inner side wall of each of the plurality of the middle-layer cylinder bodies is connected to an end part of the first support plate, and an inner side wall of the bottom-layer cylinder body is connected to an end part of the second support plate, a center of the first support plate and a center of the second support plate are rotatably connected to a bottom of the first central shaft and a bottom of the second central shaft respectively, a middle and a top of the first central shaft are respectively connected to the first material receiving plate and the first rotating screen, and a middle and a top of the second central shaft are respectively connected to the second material receiving plate and the second rotating screen;
the environment-friendly shelling system comprising: a nutshell and kernel separating machine used for separating a kernel and a nutshell, wherein the nutshell and kernel separating machine is placed beside the sheller with multilayer modules, and the first discharging port of the side wall of each of the plurality of the middle-layer cylinder bodies and the second discharging port are connected to a top inlet pipeline of the nutshell and kernel separating machine.

14. The environment-friendly shelling system according to claim 13, wherein a first circular-truncated-cone-shape sliding plate and a second circular-truncated-cone-shape sliding plate are sleeved on the first central shaft and the second central shaft respectively, a top of the first circular-truncated-cone-shape sliding plate and a top of the second circular-truncated-cone-shape sliding plate are connected to a top of the first central shaft and a top of the second central shaft respectively, and a bottom of the first circular-truncated-cone-shape sliding plate and a bottom of the second circular-truncated-cone-shape sliding plate are connected to an upper surface of the first material receiving plate and an upper surface of the second material receiving plate respectively.

15. The environment-friendly shelling system according to claim 14, wherein a first material baffle is provided between the first material receiving plate and the first rotating screen, the first material baffle is vertically suspended on an upper surface of the first material receiving plate, one end of the first material baffle which is adjacent to a corresponding one of the middle-layer cylinder bodies is connected to a side edge of the first discharging port, and an other end of the first material baffle extends to a side face of the first circular-truncated-cone-shape sliding plate; a second material baffle is provided between the second material receiving plate and the second rotating screen, the second material baffle is vertically suspended on an upper surface of the second material receiving plate, one end of the second material baffle which is adjacent to the bottom-layer cylinder body is connected to a side edge of the second discharging port, and an other end of the second material baffle extends to a side face of the second circular-truncated-cone-shape sliding plate.

16. The environment-friendly shelling system according to claim 15, further comprising a support rod, wherein the support rod is provided, from top to bottom, with a plurality of cantilever connectors rotatably connected thereto, and a cantilever end of each of the cantilever connectors is connected to a corresponding one of the side wall of the top-layer cylinder body, the side wall of each of the middle-layer cylinder bodies and the side wall of the bottom-layer cylinder body.

17. The environment-friendly shelling system according to claim 16, wherein a first lateral U-shaped positioning support is disposed between the top-layer cylinder body and one of the middle-layer cylinder bodies which is adjacent to the top-layer cylinder body; a second lateral U-shaped positioning support is disposed between the bottom-layer cylinder body and one of the middle-layer cylinder bodies which is adjacent to the bottom-layer cylinder body; and a third lateral U-shaped positioning support is disposed between every adjacent two of the middle-layer cylinder bodies.

18. The environment-friendly shelling system according to claim 13, further comprising a dust remover for removing dust from the nutshell, wherein a dust removal pipe of the dust remover is connected to a pipeline of the first discharging port of the side wall of each of the plurality of the middle-layer cylinder bodies and the second discharging port.

19. The environment-friendly shelling system according to claim 14, further comprising a dust remover for removing dust from the nutshell, wherein a dust removal pipe of the dust remover is connected to a pipeline of the first discharging port of the side wall of each of the plurality of the middle-layer cylinder bodies and the second discharging port.

20. The environment-friendly shelling system according to claim 15, further comprising a dust remover for removing dust from the nutshell, wherein a dust removal pipe of the dust remover is connected to a pipeline of the first discharging port of the side wall of each of the plurality of the middle-layer cylinder bodies and the second discharging port.
